(19) United States
(12) Patent Application Publication
(10) Pub. No.: US 2020/0323042 A1
(43) Pub. Date: Oct. 8, 2020

(54) DOUBLE-PANE QUARTZ GLASS HEATER

(71) Applicant: Shenzhen Greensmoke Technology Co., Ltd., Shenzhen (CN)

(72) Inventor: Lantian GUO, Shenzhen City (CN)

(73) Assignee: Shenzhen Greensmoke Technology Co., Ltd.

(21) Appl. No.: 16/505,988

(22) Filed: Jul. 9, 2019

(30) Foreign Application Priority Data
Apr. 2, 2019 (CN) 201920440598.4

(51) Int. Cl. H05B 3/34; A24F 47/00

(52) U.S. Cl. CPC H05B 3/34; H05B 2203/021; H05B 2203/02; A24F 47/008

(57) ABSTRACT

The present invention discloses a double-pane quartz glass heater which comprises a double-pane glass heating cup, a mesh heating element and a PTC temperature-sensing element, wherein the mesh heating element is placed in the inner chamber of the double-pane glass heating cup, the top of the PTC temperature-sensing element is welded to one end of the mesh heating element, the bottom of the PTC temperature-sensing element is welded with a PTC temperature-sensing element pin, and the other end of the mesh heating element is welded with a mesh heating element pin. The present invention solves the problem of poor taste caused by uneven baking of the tobacco tar in the existing heater.

### BACKGROUND OF THE INVENTION

### 1. Technical Field

The present invention relates to the technical field of heater, and more specifically, to a double-pane quartz glass heater.

### 2. Description of Related Art

Heating refers to the process in which a heat source transfers heat energy to a colder object in order to heat it. In general, the external manifestation is an increase in temperature, which can be directly measured by a thermometer or the like. The heating method can be generally divided into direct heating and indirect heating. As society witnesses development, people's living pressures are greater and communication is wider, which results in more and more smokers. As the time of smoking goes by, it is not easy for people having longer smoking years to quit, and the appearance of electronic cigarettes can help smoking cessation, and can also play an effect in abandoning smoking altogether. However, the baking of tobacco tar by the heater in the existing electronic cigarettes is not adequate, leading to a poor taste and being hard to be accepted by people who are quitting, so electronic cigarettes are with reduced practicality and not suitable for promotion.

### BRIEF SUMMARY OF THE INVENTION

### (I) Technical Problems to be Solved

With regard to the deficiencies of the prior art, the present invention provides a double-pane quartz glass heater with the advantages of even baking and good taste, which solves the problem of poor taste resulted from uneven baking of the tobacco tar in the existing heater.

### (II) Technical Solutions

To achieve the above objects, the present invention provides the following technical solution: a double-pane quartz glass heater, comprising a double-pane glass heating cup, a mesh heating element and a PTC temperature-sensing element, wherein the mesh heating element is placed in the inner chamber of the double-pane glass heating cup, the top of the PTC temperature-sensing element is welded to one end of the mesh heating element, the bottom of the PTC temperature-sensing element is welded with a PTC temperature-sensing element pin, the other end of the mesh heating element is welded with a mesh heating element pin, a circuit board is arranged at the bottom of the double-pane glass heating cup, the bottom of the mesh heating element pin is welded to the circuit board, and a heating zone is set inside the double-pane glass heating cup.

Preferably, the double-pane glass heating cup is made of quartz glass.

Preferably, the circuit board is powered by a battery.

Preferably, the inner chamber of the double-pane glass heating cup is filled with a thermal insulation material.

Preferably, the thermal insulation material is one of aerogel felt, glass wool or rock wool.

### (III) Advantageous Effects

Compared with the prior art, the present invention provides a double-pane quartz glass heater, which has the following advantageous effects:

1. The present invention resolved the problem of poor taste caused by uneven baking of the tobacco tar in the existing heater through mutual interaction of the double-pane glass heating cup, the mesh heating element, the PTC temperature-sensing element, the mesh heating element pin, the PTC temperature-sensing element pin, the heating zone and the circuit board. The heater can evenly heat the tobacco tar in the heating zone, so that the baking of the tobacco tar is more sufficient, thereby improving the taste of smokers, increasing the practicality of electronic cigarettes, and advancing the speed at which smokers quit. In a word, the present invention is suitable for promotion.

2. This present invention can control the heating temperature of the mesh heating element through the setting of the PTC temperature-sensing element, thus avoiding the failure to use the overheated mesh heating element, also can prevent the overflow of heat in energy saving terms and unsuitable using of too hot surface of the electronic cigarettes through the installation of the thermal insulation material, and the practicality of the heater is improved. The double-pane glass heating cup is made of quartz glass, which increases its heat resistance and avoids damage due to over high temperature, as well as improves the practicality of the heater.

### BRIEF DESCRIPTION OF THE SEVERAL VIEWS OF THE DRAWINGS

FIG. 1 is a schematic view of the structure according to the present invention;

FIG. 2 is a side view of the structure according to the present invention.

Where: 1 double-pane glass heating cup, 2 mesh heating element, 3 PTC temperature-sensing element, 4 mesh heating element pin, 5 PTC temperature-sensing element pin, 6 thermal insulation material, 7 heating zone, 8 circuit board.

### DETAILED DESCRIPTION OF THE INVENTION

With reference to the drawings in the embodiments of the present invention, the technical solution in the embodiments of the present invention are clearly and completely described. It is obvious that the embodiments described are only a part of, not all, of the embodiments of the present invention. All other embodiments obtained by those skilled in this art based on the embodiments of the present invention without creative efforts are within the protection scope of the present invention.

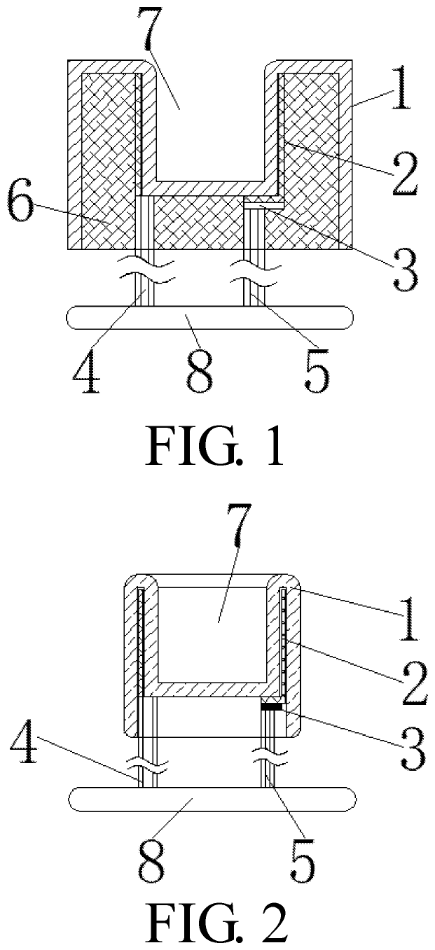

As shown in FIGS. 1-2, a double-pane quartz glass heater is disclosed, which comprises a double-pane glass heating cup 1, a mesh heating element 2, and a PTC temperature-sensing element 3. The mesh heating element 2, made of quartz glass, is placed in the inner chamber of the double-pane glass heating cup 1. The use of quartz glass for the double-pane glass heating cup 1 increases the heat resistance of the double-pane glass heating cup 1, prevents the double-pane glass heating cup 1 from being damaged due to over high temperature, and improves the practicability of the heater. The inner chamber of the double-pane glass heating cup 1 is filled with a thermal insulation material 6 which is one of aerogel felt, glass wool or rock wool. The adoption of the thermal insulation material can prevent the overflow of heat in energy saving terms, avoid unsuitable using of too hot surface of electronic cigarettes, and improve the practicality of the heater is improved. The top of the PTC temperature-sensing element 3 is welded to one end of the mesh heating element 2. The use of the temperature-sensing element 3 can control heating temperature, thereby avoiding the situation that the heat of the mesh heating element 2 is too high to be used. The PTC temperature-sensing element pin 5 is welded to the bottom of the PTC temperature-sensing element 3, the other end of the mesh heating element 2 is welded with a mesh heating element pin 4, the circuit board 8 is set at the bottom of the double-pane glass heating cup 1, the bottom of the mesh heating element pin 4 is welded to the circuit board 8 which is powered by a battery, and the heating zone 7 is set on the inner side of the double-pane glass heating cup 1. Through the mutual interaction among the double-pane glass heating cup 1, the mesh heating element 2, the PTC temperature-sensing element 3, the mesh heating element pin 4, the PTC temperature-sensing element pin 5, the heating zone land the circuit board 8, the problem of poor taste caused by uneven baking of the tobacco tar in the existing heater is solved. Besides, the heater can evenly heat the tobacco tar in the heating zone 7, so that the baking of the tobacco tar is more sufficient, thereby improving the taste of smokers, increasing the practicality of electronic cigarettes, and advancing the speed at which smokers quit. In a word, the present invention is suitable for promotion.

When in use, a user may place the tobacco tar in the heating zone 7, for which the battery provides power. This allows the circuit board 8 to control the mesh heating element 2 by the PTC temperature-sensing element 3 through the cooperation of the mesh heating element pin 4 and the PTC temperature-sensing element pin 5, and the mesh heating element 2 to bake the tobacco tar in the heating zone 7. Because the double-pane glass heating cup 1 itself is evenly heated, the tobacco tar is more adequately baked, thereby the taste is naturally improved.

To sum up, the double-pane quartz glass heater solves the problem of poor taste caused by uneven baking of the tobacco tar in the existing heater through the mutual interaction of the double-pane glass heating cup 1, the mesh heating element 2, the PTC temperature-sensing element 3, the mesh heating element pin 4, the PTC temperature-sensing element pin 5, the heating zone 7 and the circuit board 8.

Although the embodiments of the present invention have been shown and described, it should be understood that various modifications, alterations, substitutions, additions and their equivalents without departing from the spirit and scope of the present invention as defined in the Claims may be made to the embodiments by those skilled in this art.

What is claimed is:

1. A double-pane quartz glass heater, comprising a double-pane glass heating cup (1), a mesh heating element (2) and a PTC temperature-sensing element (3), wherein the mesh heating element (2) is placed in the inner chamber of the double-pane glass heating cup (1), the top of the PTC temperature-sensing element (3) is welded to one end of the mesh heating element (2), and the bottom of the PTC temperature-sensing element (3) is welded with a PTC temperature-sensing element pin (5), the other end of the mesh heating element (2) is welded with a mesh heating element pin (4), and a circuit board (8) is arranged at the bottom of the double-pane glass heating cup (1), the bottom of the mesh heating element pin (4) is welded to the circuit board (8), and a heating zone (7) is set inside the double-pane glass heating cup (1).

2. The double-pane quartz glass heater as claimed in claim 1, wherein the double-pane glass heating cup (1) is made of quartz glass.

3. The double-pane quartz glass heater as claimed in claim 1, wherein the circuit board (8) is powered by a battery.

4. The double-pane quartz glass heater as claimed in claim 1, wherein the inner chamber of the double-pane glass heating cup (1) is filled with a thermal insulation material (6).

5. The double-pane quartz glass heater as claimed in claim 4, wherein the thermal insulation material (6) is one of aerogel felt, glass wool or rock wool.
